(19) United States
(12) Patent Application Publication
(10) Pub. No.: US 2026/0273957 A1
(43) Pub. Date: Sep. 17, 2026

(54) PRINTING SYSTEM AND PRINTING METHOD

(71) Applicant: SUNTORY HOLDINGS LIMITED, Osaka-shi, Osaka (JP)

(72) Inventors: Nobuo Abiko, Minato-ku, Tokyo (JP); Kazumori Fukatani, Inuyama-shi, Aichi (JP)

(73) Assignee: SUNTORY HOLDINGS LIMITED, Osaka-shi, Osaka (JP)

(21) Appl. No.: 18/871,973

(22) PCT Filed: Jun. 9, 2023
(86) PCT No.: PCT/JP2023/021591

§ 371 Date: Dec. 5, 2024

(30) Foreign Application Priority Data
Jun. 13, 2022 (JP) 2022-095142

(51) Int. Cl. B41J 3/407; B41J 2/44

(52) U.S. Cl. CPC B41J 3/40731; B41J 2/442; B41J 3/40733

(57) ABSTRACT

To perform clear laser printing on a container being conveyed, regardless of the content of a pattern. Provided is a printing system 1 including a conveyance device 2 capable of conveying a container and a printing device 3 capable of applying printing on the container by laser. The conveyance device 2 is configured to hold top and bottom of the container and convey the held container along a predetermined path S 1, and the printing device 3 is provided at a position adjacent to the predetermined path S1 where printing can be performed on the container being conveyed by laser.

### TECHNICAL FIELD

The present invention relates to a printing system and a printing method.

### BACKGROUND ART

When a liquid product is sold, laws and regulations of each country may require the labeling information related to the liquid product. For example, when a beverage product as an example of a liquid product is sold in Japan, the beverage product is required to be labeled with the name, storage method, expiration date or best-by date, ingredient name, additives, internal volume, amount and calorie of nutritional components, name or name and address of a business operator, and location of a factory or the like for a beverage that is a content thereof (Cabinet Office Ordinance No. 10 Article 3 of Food Labeling Act). Further, when a beverage product is sold using a beverage bottle made of polyethylene terephtalate as a container, the container is required to be labeled with the material to facilitate separate collection (Article 24 of Act on the Promotion of Effective Utilization of Resources). In addition, the labeling may be required to follow guidelines set by industry organizations (e.g., Japan Soft Drink Association).

As means of providing such labeling, means of attaching a label to a container so as to surround the periphery of the container is widely used (Patent Documents 1 and 2). However, in recent years, in order to save resources, studies have been made to reduce the area of the label or to eliminate the use of the label itself. For example, Patent Document 3 discloses a method of performing laser printing on a container body.

### CITATION LIST

### Patent Document

Patent Document 1: JP 2013-212862 A
Patent Document 2: JP 2015-98350 A
Patent Document 3: JP 2021-17248 A

### SUMMARY OF INVENTION

### Technical Problem

Patent Document 3 provides a solution of providing a hollowed-out region in the pattern to solve the problem that it is difficult to perform laser printing at the conveyance speed of a container in the production of a beverage product packed in a PET bottle, while ensuring the visibility of the pattern when the region of the pattern to be printed is relatively large. Therefore, the invention of Patent Document 3 is not applicable depending on the pattern. In particular, many of items to be labeled defined by laws, guidelines, or the like are displayed by characters, and thus it is difficult to realize such labeling by the conventional laser printing technology including the invention of Patent Document 3.

Therefore, there is a need for a printing system and a printing method capable of performing clear laser printing on a container being conveyed, regardless of the content of the pattern.

### Solution to Problem

A printing system according to the present invention is a printing system including a conveyance device configured to convey a container, and a printing device configured to perform laser printing on the container. The conveyance device is configured to hold top and bottom of the container and convey the held container along a predetermined path, and the printing device is provided at a position adjacent to the predetermined path where laser printing is performed on the container being conveyed.

A printing method according to the present invention includes performing printing on a container held and conveyed by a conveying device by irradiating the container with a laser beam, the conveying device holding top and bottom of the container and conveying the held container along a predetermined path.

According to these configurations, since the container to be laser printed is in a state where the top and bottom are held, vibration accompanying conveyance is suppressed as compared with the related art. Therefore, this make it easier for the laser beam to focus on the container, so clear laser printing can be performed on the container being conveyed, regardless of the content of the pattern.

Preferred aspects of the present invention will be described below. However, the scope of the present invention is not limited by the preferred aspects described below.

In the printing system according to an aspect of the present invention, it is preferable that the conveyance device includes a rotary table being rotatable and a locator pair configured to hold top and bottom of the container, the locator pair is attached to a periphery of the rotary table, and the predetermined path is a path along a rotation track of the rotary table.

According to this configuration, the installation area for mounting the printing system according to the present invention can be reduced.

In the printing system according to an aspect of the present invention, the locator pair is preferably mounted on the rotary table in a rotatable manner.

According to this configuration, each locator pair can be positioned with respect to the printing device, making it easy to perform printing at a fixed position on the container.

The printing system according to an aspect of the present invention preferably further includes a control device capable of independently controlling rotation of the rotary table and rotation of the locator pair.

According to this configuration, the relative position of the container with respect to the printing device is precisely and easily controlled, and thus clearer printing can be performed.

In the printing system according to an aspect of the present invention, it is preferable that the control device is capable of executing a control function of controlling a rotation speed of the locator pair in accordance with a rotation speed of the rotary table, and in the control function, the rotation speed of the locator pair is determined so as to suppress a relative speed with respect to the printing device of a surface facing the printing device of the container being conveyed in a state of being held by the locator pair.

According to this configuration, clearer printing can be performed.

In the printing system according to an aspect of the present invention, the conveyance device is preferably a roll labeler.

According to this configuration, the present invention can be implemented relatively easily and inexpensively because the present invention can be implemented by diverting the roll labeler which is an existing device and whose necessity is reduced by the implementation of the present invention.

Further features and advantages of the present invention will become more apparent from the following description of exemplary and non-limiting embodiments with reference to the drawings.

### BRIEF DESCRIPTION OF DRAWINGS

FIG. 1 is a schematic view of a top surface of a printing system according to an embodiment.

FIG. 2 is a block diagram illustrating components of the printing system according to the embodiment.

FIG. 3 is a schematic view of a side surface illustrating an operation of a conveyance device according to the embodiment.

FIG. 4 is a diagram illustrating a variation of a locator pair.

### DESCRIPTION OF EMBODIMENTS

An embodiment of a printing system according to the present invention will be described with reference to the drawings. Hereinafter, an example in which the printing system according to the present invention is applied to a printing system 1 for performing laser printing on a PET bottle B (an example of a container) will be described.

### Configuration of Printing System

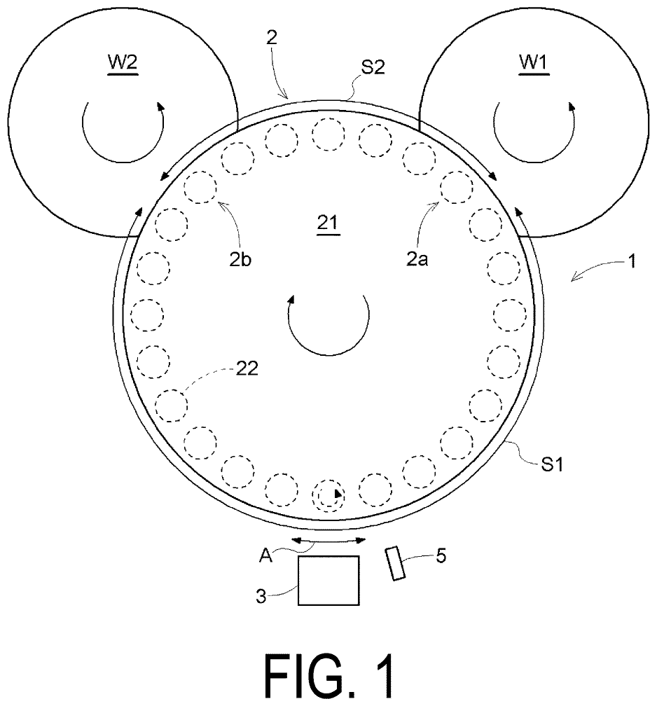

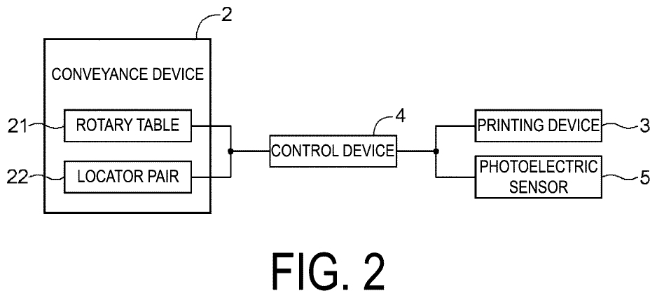

The printing system 1 according to the present embodiment includes a conveyance device 2, a printing device 3, and a control device 4 (FIGS. 1 and 2). The printing system 1 is generally a system configured to perform printing on the PET bottle B by the printing device 3 when the PET bottle B being conveyed by the conveyance device 2 passes by the printing device 3, and the operations of the conveyance device 2 and the printing device 3 are cooperatively controlled by the control device 4.

The conveyance device 2 includes a rotary table 21 and a plurality of locator pairs 22. The rotary table 21 is substantially circular in plan view. The plurality of locator pairs 22 are mounted at equal intervals along the periphery of the rotary table 21, and are configured such that the PET bottle B can be held between an upper locator 23 and a lower locator 24 constituting the locator pair 22 (this is an example of holding the top and bottom of the container). When the rotary table 21 rotates in a state in which the PET bottle B is held by the locator pair 22, the PET bottle B is conveyed along a path (an example of a predetermined path) along the rotation track of the rotary table 21. Note that the rotation of the rotary table 21 is driven by a motor (not illustrated).

The conveyance device 2 receives the PET bottle B from a wheel W1 in the previous process at a receiving position 2a. The received PET bottle B is conveyed along a path along the rotation track, and is subjected to printing by the printing device 3 in a printing region A provided in the middle of the path. The PET bottle B on which the printing has been performed is discharged to a wheel W2 in the subsequent process at a discharge position 2b.

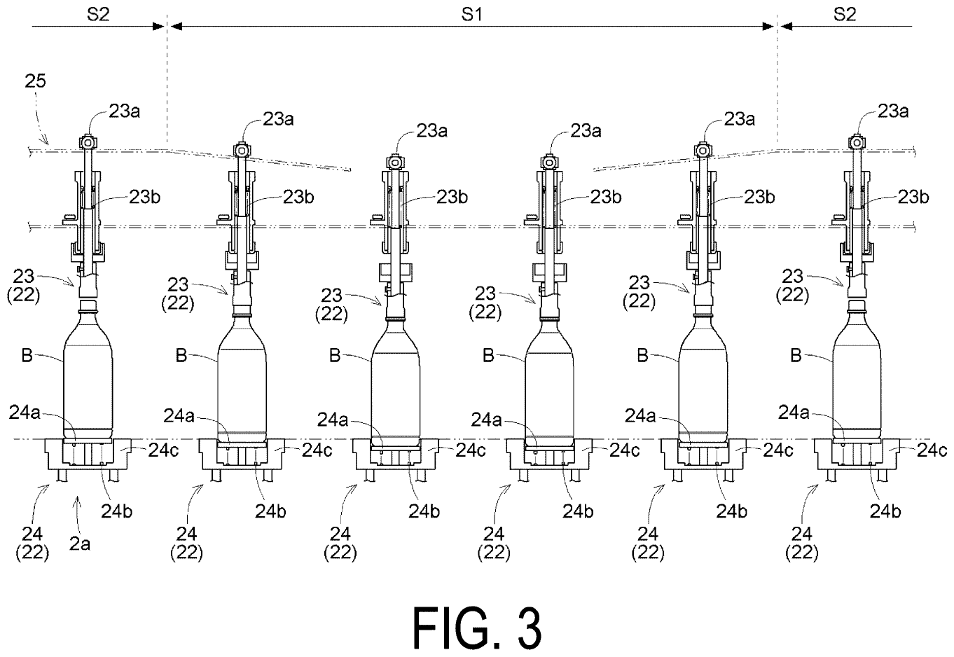

The locator pair 22 is mounted on the rotary table 21 in such a manner that the upper locator 23 is mounted on an upper plate of the rotary table 21 and the lower locator 24 is mounted on a lower plate of the rotary table 21 (FIG. 3). The upper locator 23 is configured such that a cam follower 23a provided at the upper portion thereof travels on a cam rail 25 built in the upper plate of the rotary table 21, and the vertical position of the upper locator 23 is determined by the position of the upper locator 23 in the circumferential direction. In a section S1 (FIGS. 1 and 3), the upper locator 23 travels at the lower position, and a posture in which the PET bottle B can be held between the upper locator 23 and the lower locator 24 is realized. On the other hand, in a section S2 (FIGS. 1 and 3), the upper locator 23 travels at the upper position to realize a posture in which the PET bottle B can be discharged or received. The receiving position 2a and the discharge position 2b are located at both end portions of the section S2.

The lower locator 24 includes a support plate 24a for supporting the PET bottle B, a spring 24b attached to the lower side of the support plate 24a, and a housing 24c for accommodating the support plate 24a and the spring 24b, and is configured to accommodate the bottom portion of the PET bottle B (FIG. 3). When the PET bottle B is interposed between the upper locator 23 and the lower locator 24 in the posture in which the upper locator 23 is lowered, the PET bottle B is held by the restoring force of a spring 23b of the upper locator 23 and the spring 24b of the lower locator 24.

Each locator pair 22 (the upper locator 23 and the lower locator 24) is mounted on the rotary table 21 so as to be rotatable by a motor (not illustrated). Therefore, each locator pair 22 and the PET bottle B held by the locator pair 22 can be rotated by the rotation of the rotary table 21 and rotated by the rotation of the locator pair 22. Hereinafter, the rotational movement caused by the rotation of the rotary table 21 will be referred to as revolution, and the rotational movement caused by the rotation of the locator pair 22 will be referred to as autorotation.

Note that a known device (such as an encoder) specifying the rotation angle of the rotary table 21 is provided, and a signal specifying the rotation angle is transmitted to the control device 4. Like the rotation angle of the rotary table 21, a signal specifying the rotation angle of each locator pair 22 is also transmitted to the control device 4. As a result, the control device 4 can specify the position and autorotation angle of each locator pair 22 in the revolution track at any time.

The conveyance device 2 having the above-described configuration may be mounted as a device conventionally used as a roll labeler. A known roll labeler realizes the application of a roll label to a container by a series of operations such as applying one end portion of the roll label to the container while conveying the container to which the roll label is to be attached along the revolution track and then winding the roll label around the container by autorotating the container, and a combination of a rotary table and a plurality of locator pairs is commonly used as a configuration of a roll labeler that can realize this series of operations. Therefore, generally the known roll labeler can be used as it is as the conveyance device 2 according to the present embodiment, or can be used after slight modification.

The printing device 3 is a device that can draw a desired shape on a surface of a printing object by irradiating the printing object with a laser beam to cut, melt, evaporate, or the like the surface of the printing object. The printing device 3 itself can be implemented as a known device capable of realizing the above-described functions. Basic functions and performances (a light source, a wavelength, an output, and the like of laser beam) of the printing device 3 as this type of printing device are not limited as long as printing can be performed on the PET bottle B.

The printing device 3 is provided at a position near the path along the rotation track where laser printing can be performed on the PET bottle B being conveyed. More specifically, the printing device 3 is installed such that the laser irradiation direction of the printing device 3 faces the path and the focal point thereof at least partially overlaps with the path. A region in which a range where the laser beam can be irradiated with printable intensity by the printing device 3 and the path of the PET bottle B overlap each other is a region in which printing can be performed on the PET bottle B by the printing device 3, and is set as a printing region A.

Note that a photoelectric sensor 5 is provided immediately in front of the printing region A (FIG. 1). When the PET bottle B passes through the detection range of the photoelectric sensor 5, a signal is transmitted to the control device 4. The control device 4 can recognize the entry of the PET bottle B into the printing region A based on this signal.

The control device 4 is a device capable of controlling operations of the conveyance device 2 and the printing device 3, and is implemented as, for example, a known computer. Signals for controlling the operations of the conveyance device 2 and the printing device 3 are transmitted from the control device 4 to the conveyance device 2 and the printing device 3. Various signals indicating the operating states of the conveyance device 2 and the printing device 3 are input to the control device 4. The control device 4 can also present various information to the user and accept input of various information from the user.

### Printing Method

Next, an embodiment of a printing method executed using the printing system 1 according to the present embodiment will be described. As described above, in the printing method according to the present embodiment, the PET bottle B received by the printing system 1 (the conveyance device 2) is conveyed, the printing by the printing device 3 is performed in the printing region A provided in the middle of the conveyance path, and the PET bottle B on which the printing has been performed is discharged in the subsequent process at the discharge position 2b.

Since the rotation speed of the rotary table 21 (the revolution speed of the PET bottle B) is designated by external factors such as a desired production speed and the capability of previous and subsequent processes, it is difficult to freely set the rotation speed. On the other hand, since changing the rotation speed (autorotation speed of the PET bottle B) and the rotation amount (autorotation angle of the PET bottle B) of the locator pair 22 does not affect the production speed and the previous and subsequent processes, the change can be freely set according to the convenience in printing. The rotation speed and the rotation amount of the locator pair 22 can be set in accordance with various conditions such as the conveyance speed of the container accompanying the production speed, the shape of the container, and the printing amount on the printing surface. Therefore, in the printing method according to the present embodiment, the control function of controlling the rotation speed of the locator pair 22 in accordance with the rotation speed of the rotary table 21 is executed by the control device 4 in order to facilitate clear and precise printing.

Printing by the printing device 3 is performed by an action mechanism in which a physical phenomenon such as cutting or melting is caused by applying thermal energy to a printing object by irradiating the printing object with a laser beam. For this reason, in order to appropriately perform printing, it is necessary to position the focal point of the laser beam as accurately as possible in a range of the PET bottle B where printing is desired. For this reason, the relative speed of the surface of the PET bottle B facing the printing device 3 with respect to the printing device 3 is preferably as low as possible. Therefore, in the control function, control is performed such that the locator pair 22 is rotated in the direction opposite to the rotation direction of the rotary table 21 and the relative speed due to the revolution is partially canceled (suppressed) by the autorotation. For example, when the rotary table 21 rotates clockwise, the locator pair 22 may be rotated counterclockwise (FIG. 1). Note that the rotation of the locator pair 22 may be performed at least in the printing region A, and the presence or absence of the rotation in other regions on the path is arbitrary.

However, it is necessary to sweep the laser beam with respect to the PET bottle B in order to perform printing widely in the plane direction. When the printing device 3 is moved for this sweeping, the laser beam itself may vibrate and interfere with focusing, and thus the PET bottle B should be moved. Therefore, the rotation speed of the locator pair 22 is determined so that the relative speed of the surface of the PET bottle B facing the printing device 3 with respect to the printing device 3 becomes a speed suitable for the sweeping for printing.

Note that in the printing system 1 according to the present embodiment, when printing is performed, the PET bottle B is held by the locator pair 22, and the PET bottle B can be conveyed with less vibration. This also contributes to easy focusing of the laser beam on the PET bottle B. As a result, clear and precise printing can be performed as compared with the conventional printing system. Therefore, since relatively small characters and the like, which have been difficult to be printed in the conventional technique, can be clearly printed, items (for example, a raw material name, a business operator name, and the like) which are often printed in small characters in terms of commercial habits can be printed laser printing.

The control device 4 also controls the start and stop of the rotation of the rotary table 21, the start and stop of the irradiation of the laser beam by the printing device 3, and the like.

### Other Embodiments

Finally, another embodiment of the printing system and the printing method according to the present invention will be described. Note that the configuration described in each of the following embodiments can also be applied in combination with the configuration described in another embodiment as long as no contradiction arises.

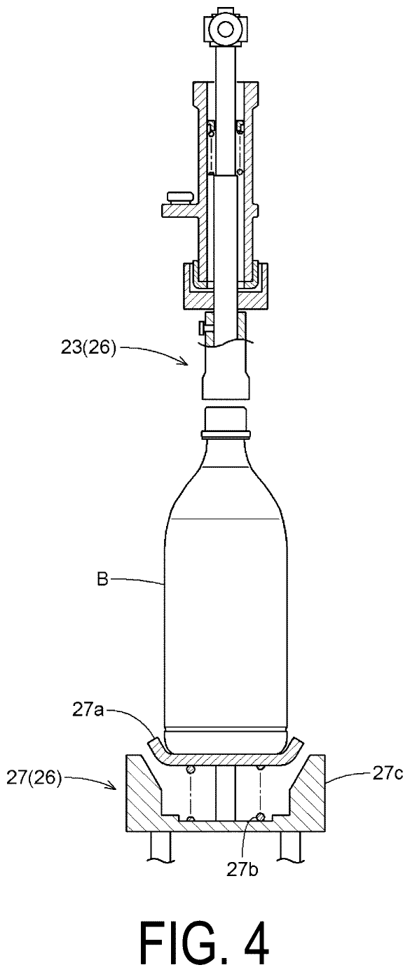

As a variation, the lower locator of the locator pair may have a shape along the bottom portion of the container. For example, in a locator pair 26 (FIG. 4) according to the variation, a support plate 27a having a shape along the bottom portion of the PET bottle B is provided at a lower locator 27. A housing 27c has a shape in which a wall surface on an inner side is cut out compared to the housing 24c of the lower locator 24 according to the above-described embodiment so that a support plate 27a can be accommodated when the support plate 27a is lowered. Note that a spring 27b is provided in the same manner as the lower locator 24 of the above-described embodiment, and the configuration of the upper locator 23 is also the same as that of the above-described embodiment. According to the locator pair 26 of the variation, since the bottom portion of the PET bottle B is supported by the lower locator 27 not only downward but also laterally, the vibration of the PET bottle B being conveyed is further suppressed.

In the above-described embodiment, the configuration in which the conveyance device 2 includes the rotary table 21 and the plurality of locator pairs 22 has been described as an example. However, the conveying device in the printing system according to the present invention is not limited as long as it can hold the top and bottom of the container and convey the held container along a predetermined path. Therefore, the conveyance path of the container is not limited to a path along the rotation track, and may be, for example, a linear path.

In the above-described embodiment, the configuration in which the locator pair 22 is rotatably mounted on the rotary table 21 has been described as an example. However, in the present invention, the locator pair may be fixed relative to the conveyance device.

In the above-described embodiment, the configuration in which the control device 4 controls the operations of the conveyance device 2 and the printing device 3 has been described as an example. However, in the printing system according to the present invention, the control device may not be provided. For example, a configuration may be employed in which the conveyance speed of the conveyance device is set to a constant value and the rotation of the locator pair is mechanically regulated.

Also, with respect to other configurations, it should be understood that the embodiments described in the present specification are illustrative in all respects and that the scope of the present invention is not limited thereto. It will be easily understood by those skilled in the art that appropriate modifications can be made without departing from the spirit of the present invention. Accordingly, other embodiments modified without departing from the spirit of the present invention are naturally included in the scope of the present invention.

### INDUSTRIAL APPLICABILITY

The present invention is applicable to, for example, a printing system for applying printing on a PET bottle by laser.

### REFERENCE SIGNS LIST

1: Printing system
2: Conveyance device
2a: Receiving position
2b: Discharge position
3: Printing device
4: Control device
5: Photoelectric sensor
21: Rotary table
22: Locator pair
23: Upper locator
23a: Cam follower
23b: Spring
24: Lower locator
24a: Support plate
24b: Spring
24c: Housing
25: Cam rail
26: Locator pair (variation)
27: Lower locator (variation)
27a: Support plate (variation)
27b: Spring (variation)
27c: Housing (variation)
A: Printing region
B: PET bottle

1. A printing system comprising:
a conveyance device configured to convey a container; and
a printing device configured to perform laser printing on the container, wherein
the conveyance device is configured to hold top and bottom of the container and convey the container being held along a predetermined path, and
the printing device is provided at a position adjacent to the predetermined path where laser printing can be performed on the container being conveyed.

2. The printing system according to claim 1, wherein
the conveyance device includes a rotary table being rotatable and a locator pair configured to hold the top and bottom of the container,
the locator pair is mounted to a periphery of the rotary table, and
the predetermined path is a path along a rotation track of the rotary table.

3. The printing system according to claim 2, wherein the locator pair is rotatably mounted to the rotary table.

4. The printing system according to claim 3, further comprising a control device configured to independently control rotation of the rotary table and the locator pair.

5. The printing system according to claim 4, wherein
the control device is capable of executing a control function of controlling a rotation speed of the locator pair in accordance with a rotation speed of the rotary table, and
in the control function, the rotation speed of the locator pair is determined so as to suppress a relative speed with respect to the printing device of a surface, facing the printing device, of the container being conveyed in a state of being held by the locator pair.

6. The printing system according to claim 1, wherein the conveyance device is a roll labeler.

7. A printing method comprising:
performing printing on a container held and conveyed by a conveying device by irradiating the container with a laser beam, the conveying device holding top and bottom of the container and conveying the held container along a predetermined path.
